(19) United States
(12) Patent Application Publication
(10) Pub. No.: US 2025/0223912 A1
(43) Pub. Date: Jul. 10, 2025

(54) MONITORING COMPRESSOR PERFORMANCE

(71) Applicant: Saudi Arabian Oil Company, Dhahran (SA)

(72) Inventors: Mohammad Almusaiteer, Al'Udhailiyah (SA); Abdulrahman Takrouni, Al Mubarraz (SA); Fahad Alghamdi, Al Mubarraz (SA)

(21) Appl. No.: 18/404,267

(22) Filed: Jan. 4, 2024

(51) Int. Cl. F01D 21/00; F02C 9/28; G01M 15/14; G08B 21/18

(52) U.S. Cl. CPC F01D 21/003; F02C 9/28; G01M 15/14; G08B 21/18; F05D 2260/80; F05D 2260/81; F05D 2270/20

(57) ABSTRACT

This disclosure describes systems and methods for controlling a gas turbine driven compressor. A method includes measuring physical parameters of the gas turbine driven compressor; determining an efficiency of the gas turbine driven compressor based on the measured physical parameters, wherein the efficiency includes a compressor polytropic efficiency, an absorbed compressor power, and a thermal efficiency of the gas turbine driven compressor; determining that the efficiency is less than a peak efficiency of the gas turbine driven compressor; and in response, adjusting setpoints of the gas turbine driven compressor to increase the efficiency of the gas turbine driven compressor.

### TECHNICAL FIELD

The present disclosure relates to methods and systems for monitoring compressor performance, for example, monitoring the performance of a gas turbine driven compressor.

### BACKGROUND

Gas turbine driven compressors are used, for example, in the oil and gas industry. The gas turbine burns fuel, e.g., natural gas, to generate power for the compressor to pressurize a process gas. Over time, the efficiency of a gas turbine driven compressor can change due to, among other things, ageing equipment or equipment failure.

### SUMMARY

This disclosure describes systems and methods for monitoring performance and controlling a gas turbine driven compressor. A data processing system (e.g., a control system or a computer) measures physical parameters of the gas turbine driven compressor. The data processing system determines an efficiency of the gas turbine driven compressor based on the measured physical parameters. The efficiency includes a compressor polytropic efficiency, an absorbed compressor power, and a thermal efficiency of the gas turbine. The data processing system determines that the efficiency is less than a threshold (e.g., peak) efficiency of the gas turbine driven compressor, and in response, the data processing system adjusts setpoints of the gas turbine driven compressor to increase the efficiency of the gas turbine driven compressor.

Implementations of the systems and methods of this disclosure can provide various technical benefits. For example, gas turbine driven compressors can be continuously monitored in real time to detect faults and long term and short term performance deterioration. Performance deteriorations can be used to identify unexpected failures (e.g., seal failure, O-ring failure, passing valves, tubing aging, fouling, and so forth). Real time calculation of compressor polytropic efficiency and efficiency rate of change monitoring can trigger automatic corrective actions, alarms, and guide messages for operators. The measured physical parameters and determined efficiency can be used to form a “digital twin” of the gas turbine driven compressor useful for verifying machine power torque meter health and/or a backup when the machine power torque meter is unavailable. Gas turbine thermal efficiency can be an indicator of the health of the gas turbine and can provide an early indication of turbine performance deteriorations.

The systems and methods of this disclosure can display (e.g., on a display device) a current operating point of the gas turbine driven compressor on a performance curve showing, for example, actual surge and stonewall limits of the compressor and deviations from the limits. The system can include a multivariable control system to adjust setpoints of the compressor operating parameters to maximize the efficiency of the equipment. Operating the equipment at maximum efficiency can lead to energy savings and equipment longevity. A machine learning model, such as a linear regression model, can be trained using actual efficiency data collected from the system, and the machine learning model can be used to predict changes in the efficiency for the different operation modes such as startup of the compressor, shutdown of the compressor, tripping of a piece of the equipment, and maximum capacity operations.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 is a schematic diagram of a gas turbine driven compressor system, according to some implementations.

FIG. 2 is a block diagram of a gas turbine driven compressor system, according to some implementations.

FIG. 3 is a flow chart of an example method for controlling a gas turbine compressor, according to some implementations.

FIG. 4 is an example graphical user interface (GUI) for monitoring performance of a gas turbine compressor, according to some implementations.

FIG. 5 is another example GUI for monitoring performance of a gas turbine compressor, according to some implementations.

FIG. 6 illustrates hydrocarbon production operations that include field operations and computational operations, according to some implementations.

FIG. 7 is a block diagram illustrating an example computer system used to provide computational functionalities associated with described algorithms, methods, functions, processes, flows, and procedures according to some implementations of the present disclosure. Like reference symbols in the various drawings indicate like elements.

### DETAILED DESCRIPTION

This disclosure describes systems and methods for monitoring performance and controlling a gas turbine driven compressor. A data processing system (e.g., a control system or a computer) measures physical parameters of the gas turbine driven compressor. The data processing system determines an efficiency of the gas turbine driven compressor based on the measured physical parameters. The efficiency includes a compressor polytropic efficiency, an absorbed compressor power, and a thermal efficiency of the gas turbine. The data processing system determines that the efficiency is less than a peak efficiency of the gas turbine driven compressor, and in response, the data processing system adjusts setpoints of the gas turbine driven compressor to increase the efficiency of the gas turbine driven compressor.

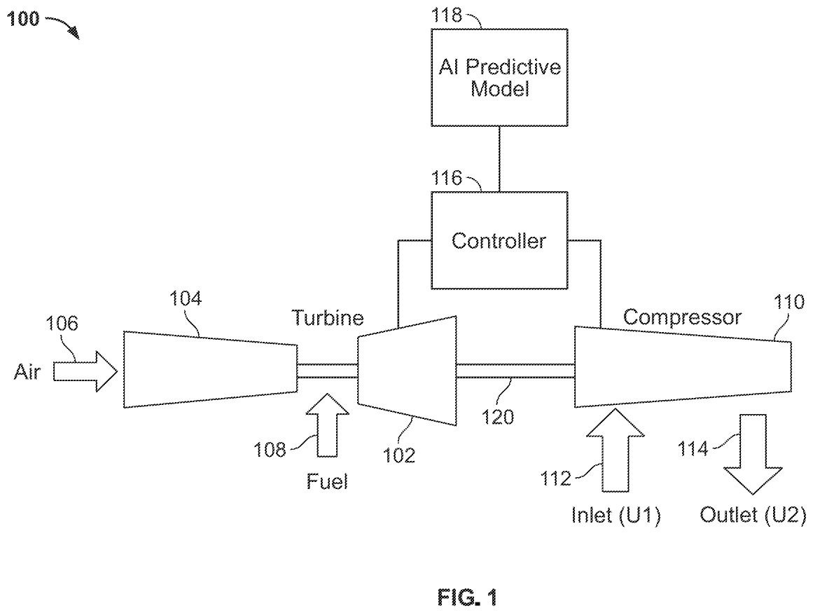

FIG. 1 is a schematic of an example gas turbine driven compressor system 100. The system 100 includes a gas turbine 102 and a gas compressor 110. A power shaft 120 couples the turbine 102 to the compressor 110. The power shaft 120 transfers rotational mechanical energy from the turbine 102 to the compressor 110. Air 104 enters an inlet 106 of the turbine 102. The air 104 mixes with fuel 108 and combusts the mixture to power the turbine 102. The compressor 110 receives low pressure process gas through an inlet 112. The compressor 110 compresses the process gas to increase the gas pressure. High pressure process gas flows from the outlet 114 of the compressor 110.

A controller 116 is communicatively coupled to the turbine 102 and the compressor 110. The controller 116 can be, for example, a distributed control system integrated with the gas turbine driven compressor. The controller 116 can obtain measurements of physical parameters of the system 100 from sensors installed within the system 100. The controller can be in communication with an artificial intelligence (AI) predictive model 118. In some implementations, the AI predictive model 118 is stored in memory of the controller 116 and executed by the controller 116. In some implementations, the AI predictive model 118 is stored in memory of and executed by a separate data processing system (e.g., a computer) that is communicatively coupled to the controller 116. The controller 116 can be coupled to the turbine 102, the compressor 110, and the AI predictive model 118 through a local area network, over a wireless or wired link, on a cellular network, and/or over the Internet.

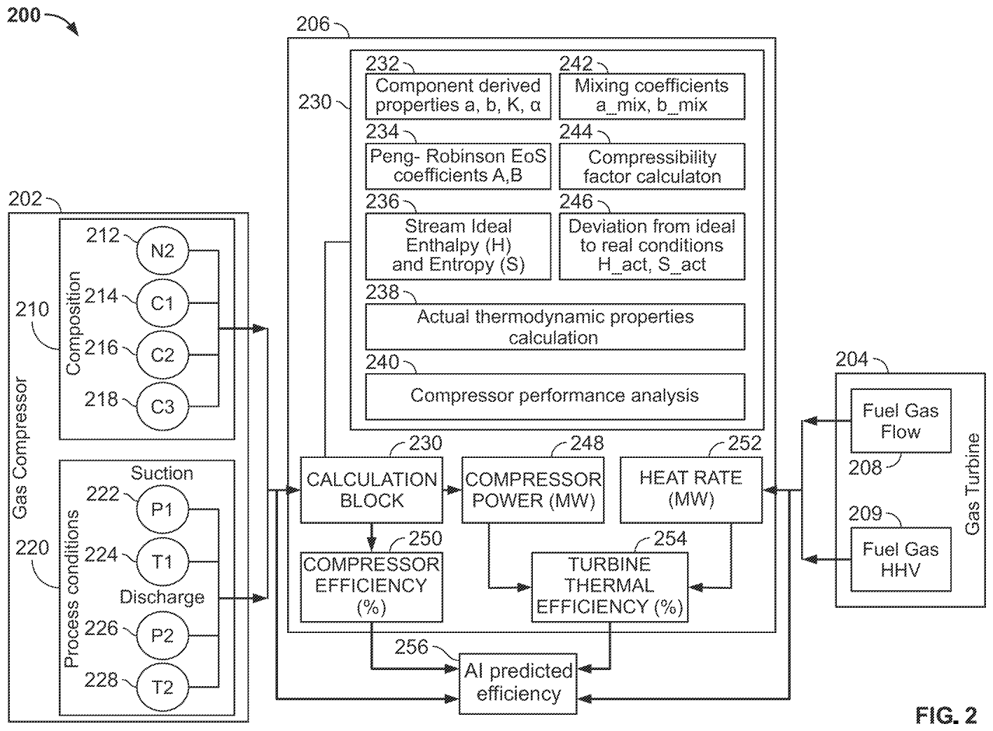

FIG. 2 is as block diagram of another example gas turbine driven compressor system 200. The system 200 includes gas compressor 202, gas turbine 204, and controller 206. The controller 206 is in electronic communication with the compressor 202 and the turbine 204. The controller 206 receives electronic signals from the turbine 204 indicating measurements of fuel gas flow 208 and fuel gas high heating value (HHV) 209. The controller 206 receives electronic signals from the compressor 202 indicating gas compositions 210 and process conditions 220. The gas compositions 210 include molar fractions of gas components in the process gas. Four components are shown: nitrogen N2 212, methane C1 214, ethane C2 216, and propane C3 218. The process conditions 220 include the suction pressure P1 222, the suction temperature T1 224, the discharge pressure P2 226, and the discharge temperature 228. In some implementations, the compressor 110 has multiple stages, and the process conditions 220 include the suction and discharge pressures and temperatures for each stage.

Based on the measurements of physical parameters received from the turbine 204 and the compressor 202, the controller 206 determines additional indicators to assess the performance of the system 200. In calculation block 230, the controller 206 determines gas component derived properties 232, Peng-Robinson equation of state coefficients 234, process stream ideal enthalpy (H) and entropy(S) 236, actual values of thermodynamic properties 238, mixing coefficients 242, compressibility factors 244, deviation of enthalpy and entropy from ideal conditions 246 and compressor performance analysis 240. Additional details of calculation block 230 will be discussed later.

Based on the additional parameters determined in calculation block 230, the controller 206 determines the absorbed compressor power 248 and compressor efficiency 250. The controller 206 determines a heat rate 252 of the turbine 204 using the fuel gas flow 208 and the fuel gas HHV 209. The compressor power 248 and heat rate 252 can be used to determine a thermal efficiency 254 of the turbine 204.

The AI predicted efficiency 256 includes a machine learning model (e.g., a linear regression model, a logistic regression model, a polynomial regression model, a ridge regression model)

that is trained based on the physical parameters from the compressor 202 (gas composition 210 and process conditions 220) and turbine 204 (fuel gas flow 208 and fuel gas HHV 209). Labeled training data includes the compressor efficiency 250 and turbine thermal efficiency 254 corresponding to the physical parameters. The machine learning model outputs a time series of future efficiency values of the system 200. The AI predicted efficiency 256 indicates future performance of the system 200. Based on the predicted efficiency, the controller 206 can adjust setpoints of the gas compressor 202 and/or turbine 204 to improve the future performance. Setpoints can include target values for physical parameters and/or equipment settings of the gas turbine driven compressor. For example, the AI predicted efficiency 256 can indicate a decline in the efficiency of the system 200, and based on the decline, the controller 206 can generate control commands to adjust setpoints such as valve positions, a flow rate of process gases, heat exchanger conditions, and ratios of gas components in the process gas.

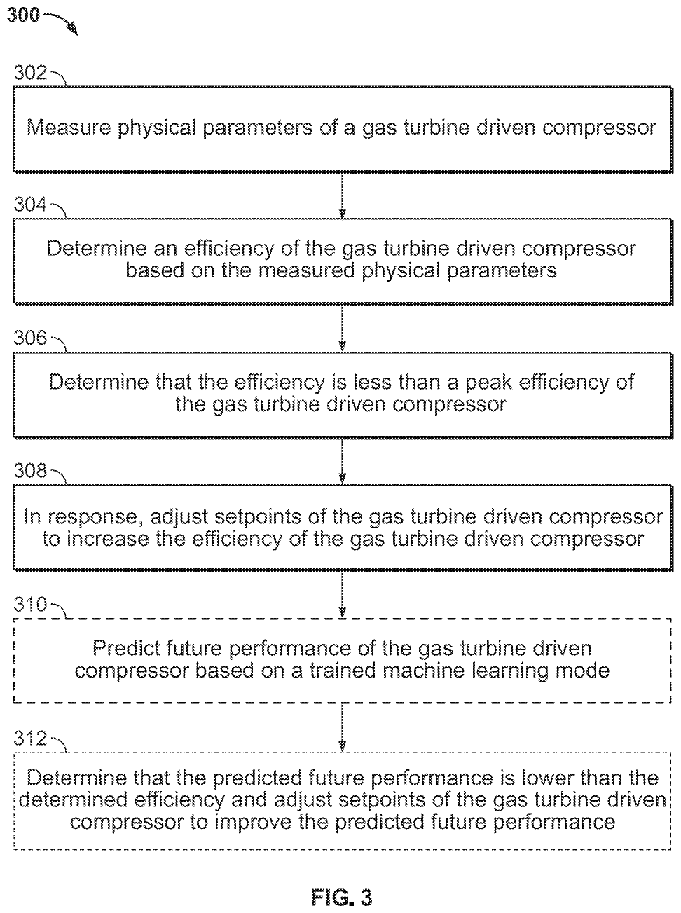

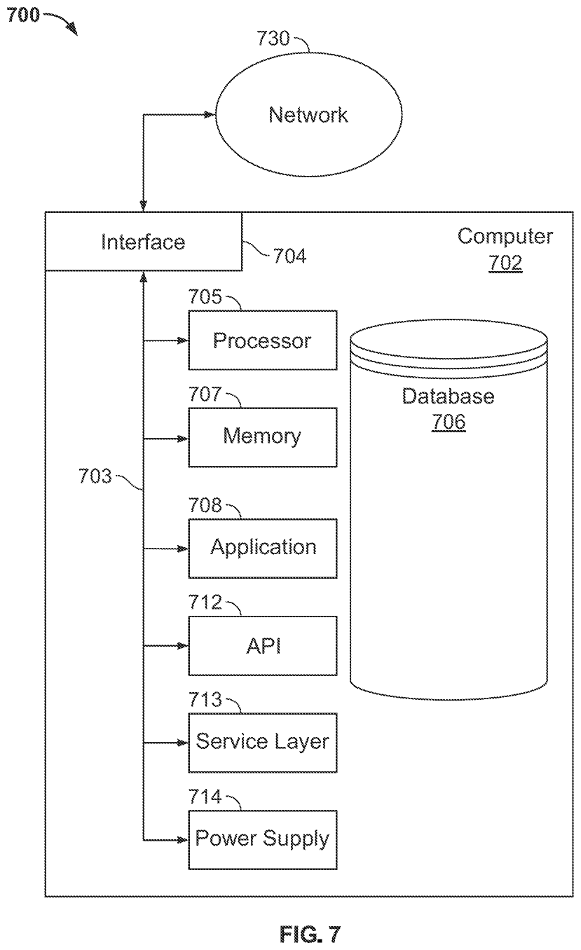

FIG. 3 is a flow chart for an example method 300 for controlling a gas turbine driven compressor. The method 300 can be implemented on a data processing system such as a computer or control system (e.g., controllers 116, 206 or the computer system of FIG. 7).

At step 302, the data processing system measures physical parameters of the gas turbine driven compressor (e.g., systems 100 or 200). The physical parameters can include a composition of the process gas that is being compressed by the compressor, process conditions (e.g., temperatures and pressures of the process gas), and gas turbine parameters (e.g., fuel flow rate and fuel HHV). The physical parameters can be measured using physical sensors coupled to the gas turbine driven compressor. The physical sensors can include, for example, pressure transducers, thermocouples, spectrometers, flow meters, and so forth. The physical sensors can transmit electronic signals to the data processing system that indicate the value of the measured physical parameter.

At step 304, the data processing system determines an efficiency of the gas turbine driven compressor based on the measured physical parameters. The efficiency can include a compressor polytropic efficiency, an absorbed compressor power, and a thermal efficiency of the gas turbine. In some examples, the compressor polytropic efficiency is based on a Peng-Robinson equation of state.

In some examples, the data processing system determines additional parameters of the gas turbine driven compressor (e.g., parameters in calculation block 230) based on the measured physical parameters. The additional parameters can function as digital sensors that are useful for monitoring the efficiency and performance of the gas turbine driven compressor. The data processing system can use the additional parameters to form a digital twin of the gas turbine driven compressor.

In some examples, the data processing system verifies machine power torque meter health based on the determined efficiency, measured physical parameters, and/or additional parameters. In some examples, the data processing system provides machine power torque readings when the machine power torque meter is unavailable.

At step 306, the data processing system determines that the efficiency is less than a peak efficiency of the gas turbine driven compressor. The peak efficiency can be based on, for example, the design parameters of the gas turbine driven compressor or on past performance of the gas turbine driven compressor. An efficiency less than the peak efficiency can indicate, for example, that setpoints of the gas turbine driven compressor are set incorrectly or that a piece of equipment (e.g., seals, O-rings, valves, etc.) has failed or is failing.

At step 308, in response to determining that the efficiency is less than a peak efficiency the data processing system adjusts setpoints of the gas turbine driven compressor. For example, the data processing system generates control commands to control the position of valves, flow rates of a flow gas, heat exchanger settings, and/or gas composition ratios. Example parameter setpoints include gas flow rate to the gas turbine driven compressor, an outlet temperature for a heat exchanger, a gas pressure, and split ratio of the flow rate between an overhead heat exchanger and a turboexpander. In some examples, the data processing system adjusts the setpoints within previously specified constraints (e.g., upper and lower bounds for setpoints).

In some examples, the data processing system determines that the gas turbine driven compressor is approaching a surge or a stonewall zone based on the measured physical parameter and determined efficiency. A surge zone is, for example, an operating zone where flow within the compressor is reversed. A stonewall zone is, for example, an operating zone where flow within the compressor has a velocity equal to the speed of sound. Surge and stonewall zones can lead to early failure of the gas turbine driven compressor (e.g., failure of the compressor's impellor).

In response to determining that the gas turbine driven compressor is approaching a surge or stonewall zone, the data processing system can generate one or more alarms to alert operators to the conditions of the gas turbine driven compressor. In this manner, the data processing system functions as an early warning system. In some implementations, when the alarm is unresolved by the operator, the data processing system generates control commands to shutdown the gas turbine driven compressor, for example, using an emergency shutdown system.

In some examples, the data processing system predicts future performance of the gas turbine driven compressor using a trained machine learning model. The performance can be measured by the efficiency of the gas turbine compressor. The machine learning model takes as input the measured physical parameters and outputs a time series of values of predicted efficiency. For example, the machine learning model can predict the efficiency of the compressor for a week or more, two weeks or more, a month or more. The data processing system can train the machine learning model based on historical data collected from the gas turbine driven compressor. For example, the data processing system can form a training dataset including measured physical parameters labeled with corresponding determined efficiencies. Including historical data from a variety of operating conditions of the gas turbine compressor can improve the generalization of the machine learning model.

The data processing system can determine that the predicted future performance of the gas turbine driven compressor is less than the determined efficiency and/or peak efficiency. For example, the data processing system can determine that the predicted future performance is decreasing or trending downward. In response, the data processing system can adjust setpoints of the gas turbine compressor to improve the future performance, for example, in a feedforward control scheme.

In some examples, the data processing system renders a graphical user interface for display on a display device. The GUI includes visual representations of the measured physical parameters and determined efficiency. The display device can be integral to the data processing system or external to the data processing system.

In some examples, the data processing system performs the method 300 in real-time. Real-time or near real-time processing and/or communication refers to a scenario in which received data (e.g., measured physical parameters) are processed as made available to systems and devices requesting those data immediately (e.g., within milliseconds, tens of milliseconds, or hundreds of milliseconds) after the processing of those data are completed, without introducing data persistence or store-then-forward actions. In this context, a real-time data processing system is configured to process parameters of the gas turbine driven compressor as quickly as possible (though processing latency may occur). Though data can be buffered between module interfaces in a pipelined architecture, each individual module operates on the most recent data available to it. The overall result is a workflow that, in a real-time context, receives a data stream (e.g., measured physical parameters) and outputs processed data (e.g., determined efficiency) based on that data stream in a first-in, first out manner. However, non-real-time contexts are also possible, in which data are stored (either in memory or persistently) for processing at a later time. In this context, modules of the data processing system do not necessarily operate on the most recent data available.

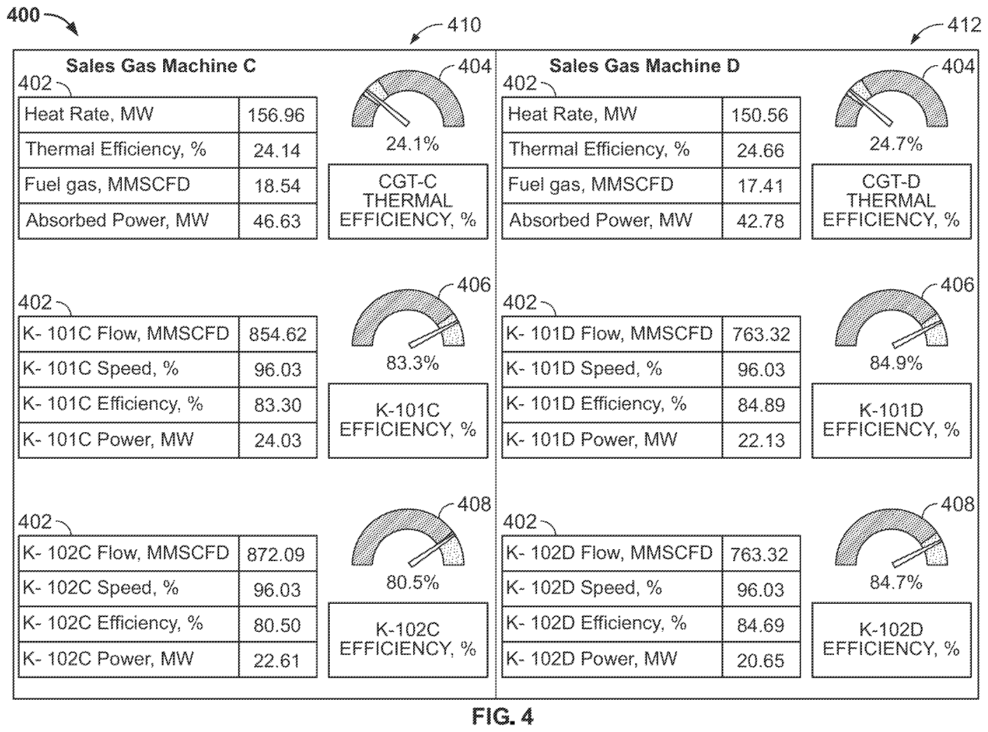

FIG. 4 is an illustration of an example GUI 400. The GUI 400 can be, for example, part of a dashboard rendered for display on a display device for an operator. The GUI 400 includes tables of values 402 indicating the measured physical parameters and efficiencies of the gas turbine compressor. The GUI 400 also includes dials 404, 406, 408 that provide a visual representation of the efficiencies of the system. In this example, parameters 410, 412 for two gas turbine driven compressors are shown; however, more or fewer gas turbine driven compressors can be shown.

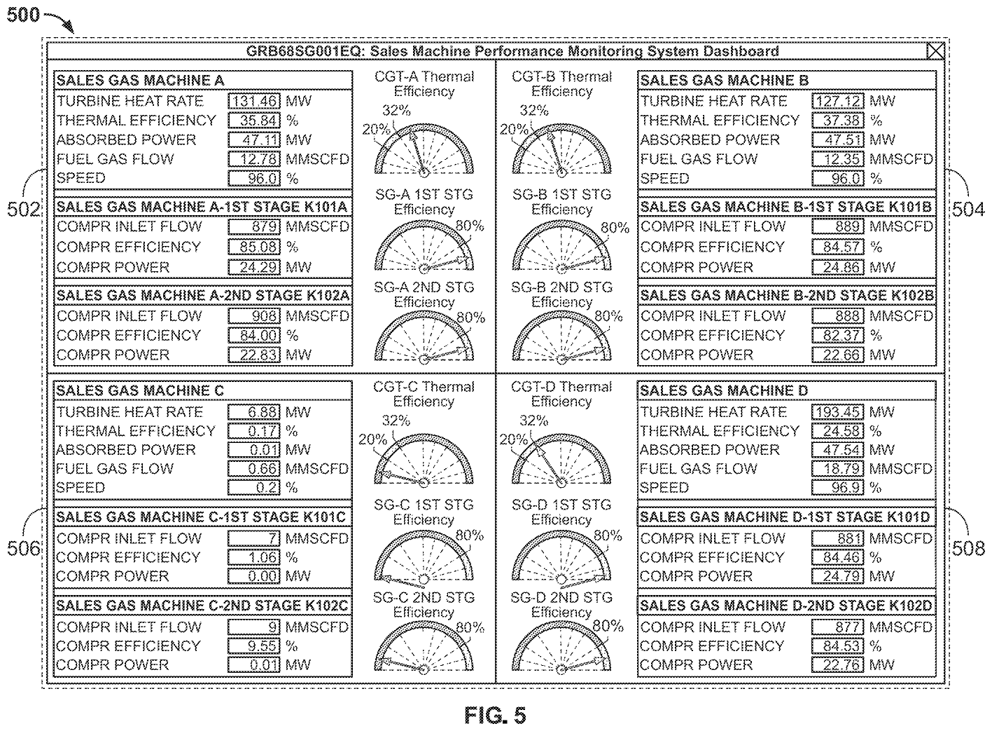

FIG. 5 is another example GUI 500. In this example, parameters for four gas turbine driven compressors 502, 504, 506, 508 are shown. The GUI can include colors to indicate that a parameter is in range or out of range. For example, in fields where parameters are in range, the field can be colored green. If the parameter is near the boundary of the range, the parameter can be colored yellow or orange. If the parameter is out of range the field can be colored red. Other color schemes are also possible.

The following sections show example equations that can be incorporated into calculation blocks (e.g., calculation block 230) of the controller. For gas turbine driven compressors having multiple compressor stages, the calculations can be repeated for each stage. Examples below are shown for a two stage Gas Turbine Driven Centrifugal Compressor.

### Gas Turbine Driven Compressor Parameter Calculations

Input data includes gas composition (N2, C1, C2, C3), suction parameters (temperature (T1), pressure (P1), flow (F), and speed(S)), and discharge parameters (pressure (P2) and temperature (T2)). Constants include standard conditions (pressure (Pstd) and temperature (Tstd)), reference conditions (pressure (Pref) and temperature (Tref)), and a gas constant (R).

TABLE 1
Component derived properties

| Component | a | b | K | AA |
|---|---|---|---|---|
| N2 | 0.148 | 2.41*10\hat{ }−5 | 0.436 | 0.148* α_{N2} |
| C1 | 0.248 | 2.66*10\hat{ }−5 | 0.392 | 0.248* α_{C1} |
| C2 | 0.604 | 4.05*10\hat{ }−5 | 0.524 | 0.604* α_{C2} |
| C3 | 1.016 | 5.62*10\hat{ }−5 | 0.603 | 1.016* α_{C3} |

### Calculate α and AA for Each Component:

$$α = {( 1 + K \cdot ( 1 - \sqrt{\frac{T}{{T}_{c}}} ) )}^{2}$$

Calculate Mixing Parameters for Each Component Mixing with Each Other Component:

$${M}_{N 2 N 2} = {y}_{N 2} * {y}_{N 2} * A {A}_{N 2}$$

$${M}_{C 1 C 1} = {y}_{C 1} * {y}_{C 1} * A {A}_{C 1}$$

$${M}_{C 2 C 2} = {y}_{C 2} * {y}_{C 2} * A {A}_{C 2}$$

$${M}_{C 3 C 3} = {y}_{C 3} * {y}_{C 3} * A {A}_{C 3}$$

$${M}_{N 2 C 1} = 0.964 * {y}_{N 2} * {y}_{C 1} * {( A {A}_{N 2} * A {A}_{C 1} )}^{0.5}$$

$${M}_{N 2 C 2} = 0.95 * {y}_{N 2} * {y}_{C 2} * {( A {A}_{N 2} * A {A}_{C 2} )}^{0.5}$$

$${M}_{N 2 C 3} = 0.92 * {y}_{N 2} * {y}_{C 3} * {( A {A}_{N 2} * A {A}_{C 3} )}^{0.5}$$

$${M}_{C 1 C 2} = 0.998 * {y}_{C 1} * {y}_{C 2} * {( A {A}_{C 1} * A {A}_{C 2} )}^{0.5}$$

$${M}_{C 1 C 3} = 0.993 * {y}_{C 1} * {y}_{C 3} * {( A {A}_{C 1} * A {A}_{C 3} )}^{0.5}$$

$${M}_{C 2 C 3} = 0.9987 * {y}_{C 2} * {y}_{C 3} * {( A {A}_{C 2} * A {A}_{C 3} )}^{0.5}$$

$${MIX}_{N 2} = {M}_{N 2 N 2} + {M}_{N 2 C 1} + {M}_{N 2 C 2} + {M}_{N 2 C 3}$$

$${MIX}_{C 1} = {M}_{C 1 C 1} + {M}_{N 2 C 1} + {M}_{C 1 C 2} + {M}_{C 1 C 3}$$

$${MIX}_{C 2} = {M}_{C 2 C 2} + {M}_{N 2 C 2} + {M}_{C I C 2} + {M}_{C 2 C 3}$$

$${MIX}_{C 3} = {M}_{C 3 C 3} + {M}_{N 2 C 3} + {M}_{C I C 3} + {M}_{C 2 C 3}$$

Calculate Mixing Coefficients (α·α)^{mix} and b^{mix}

$${( a \cdot α )}^{m i x} = {MIX}_{N 2} + {MIX}_{C 1} + {MIX}_{C 2} + {MIX}_{C 3}$$

$${b}^{m i x} = \sum {y}_{i} \cdot {b}_{i}$$

### Calculate Coefficients (a, B) for the Peng-Robinson Equation of State:

$$A = \frac{{( a \cdot α )}^{mix} \cdot P}{{R}^{2} \cdot {T}^{2}}$$

$$B = \frac{{b}^{mix} \cdot P}{R \cdot T}$$

### Calculate a Compressibility Factor (Z) for Each Stage of the Compressor by Solving the Peng-Robinson Equation of State as Follows

$${Z}^{3} + a \cdot {Z}^{2} + b \cdot Z + c = 0$$

$$a = B - 1$$

$$b = A - 2 B - 3 \cdot {B}^{2}$$

$$c = {B}^{3} + {B}^{2} - A \cdot B$$

If there is no significant variation in gas composition, a correlation can be calculated, and the Z-factor (Z1—suction and Z2—discharge) can be estimated from the correlation.

$$Z = a + ( b * T ) + ( c * P ) + ( d * {T}^{2} ) + ( e * {P}^{2} ) + ( f * T * P )$$

where T is the stream temperature in F, P is the stream pressure in psig, and a, b, c, d, e, f are equation coefficients. Table 2 gives values for the equation coefficients for a first stage of the compressor and Table 3 gives values for a second stage of the compressor.

TABLE 2
First compressor stage equation coefficients

| Coefficient | Suction (1st stage) | Discharge (1st stage) |
|---|---|---|
| a | 0.98611117 | 0.97078451 |
| b | 0.00014451965 | 0.00021277806 |
| c | −0.00015983955 | −0.0001137374 |
| d | −4.8358586*10\hat{ }−7 | −3.7698788*10\hat{ }−7 |
| e | −1.1878376*10\hat{ }−8 | 1.7066267*10\hat{ }−8 |
| f | 5.7500381*10\hat{ }−7 | 2.5064383*10\hat{ }−7 |

TABLE 3
Second compressor stage equation coefficients

| Coefficient | Suction (2nd stage) | Discharge (2nd stage) |
|---|---|---|
| a | 0.97655441 | 0.94320209 |
| b | 0.00028123367 | 0.00039559504 |
| c | −0.00016602302 | −0.00010011173 |
| d | −8.9316239*10\hat{ }−7 | −6.8181818*10\hat{ }−7 |
| e | 1.6619744*10\hat{ }−8 | 1.2555626*10\hat{ }−8 |
| f | 5.2085188*10\hat{ }−7 | 2.1338207*10\hat{ }−7 |

To calculate enthalpy (H), a reference enthalpy (H_{ref}) is defined at a given temperature and pressure then the change in enthalpy is calculated with reference to the actual pressure and temperature in two steps-first an ideal step (no change in pressure) (dH^{ideal}), then a departure function (H^{departure}) to account for non-ideal behavior at high pressure:

$$H = {H}_{ref} + d {H}^{ideal} + {H}^{departure} .$$

The reference enthalpy is a sum of component mole fractions (yᵢ) multiplied by an enthalpy of formation (dHᵢ⁰) at the reference conditions, where i is an index corresponding to the component.

$${H}_{ref} = \sum {y}_{i} \cdot {dH}_{i}^{0}$$

TABLE 4
Component Enthalpy and Entropy of Formation

| Component | dHᵢ⁰, kJ/kmol | dSᵢ⁰, kJ /(kmol · K) |
|---|---|---|
| Nitrogen | 0 | 148.063 |
| Methane | −74900 | 183.476 |
| Ethane | −84738 | 195.219 |
| Propane | −103890 | 161.655 |

### Calculate Ideal Enthalpy for Each Component:

$$d \text{} {H}_{i}^{ideal} = \text{} A \cdot \text{} ( T - {T}_{ref} ) + \text{} \frac{B}{2} \cdot \text{} ( {T}^{2} - {T}_{ref}^{2} ) + \text{} \frac{C}{3} \cdot ( {T}^{3} - {T}_{ref}^{3} ) + \text{} \frac{D}{4} \cdot ( {T}^{4} - {T}_{ref}^{4} ) + \frac{E}{5} \cdot \text{} ( {T}^{5} - {T}_{ref}^{5} )$$

where T_{ref} is a reference temperature (e.g., 298.15 K); T is an actual temperature; and A, B, C, D, E are coefficients given in Table 5.

TABLE 5
Ideal Enthalpy Coefficients

| Component | A | B | C | D | E |
|---|---|---|---|---|---|
| Nitrogen | 2.753E+01 | 5.443E−03 | −3.494E−08 | −4.096E−10 | 5.673E−14 |
| Methane | 3.793E+01 | −6.842E−02 | 2.725E−04 | −2.390E−07 | 6.906E−11 |
| Ethane | 3.437E+01 | −1.946E−02 | 3.828E−04 | −4.081E−07 | 1.326E−10 |
| Propane | 1.742E+01 | 1.865E−01 | 5.245E−05 | −1.177E−07 | 3.703E−11 |

### Calculate Ideal Enthalpy for the Mixture:

$$d {H}_{ideal} = \sum {y}_{i} \cdot {dH}_{i}^{ideal}$$

### Calculate Departure Enthalpy:

$${H}^{departure} = ( 1 - Z - ln \frac{Z + ( 1 + \sqrt{2} ) \cdot B}{Z + ( 1 - \sqrt{2} ) B} \cdot \frac{A}{B \cdot \sqrt{8}} \cdot ( 1 + {K}^{mix} \cdot \frac{\sqrt{\frac{T}{{T}_{c}^{mix}}}}{\sqrt{{α}^{mix}}} ) ) \cdot R \cdot T$$

where Z is a compressibility of the gas; T_{c}^{mix} is critical temperature of the gas mixture; A, B are coefficients from Peng-Robinson EOS; α^{mix}, K^{mix} are component-derived properties for the gas mixture, and R is the gas constant, 8.3144)/(mol·K).

The critical temperature for the gas mixture is calculated as:

$${T}_{c}^{mix} = \sum {T}_{i}^{c} \cdot {y}_{i}$$

where Tᵢ^{c} is a critical temperature of the component i.

TABLE 6
Gas Component Parameters

| | Mol Weight | T_{c} | P_{c} |
|---|---|---|---|
| Component | kg/kmol | K | kPa |
| Nitrogen | 28.013 | 126.194 | 3394.37 |
| Methane | 16.043 | 190.699 | 4640.68 |
| Ethane | 30.070 | 305.428 | 4883.85 |
| Propane | 44.097 | 369.898 | 4256.66 |

Similar to the critical temperature, parameters K and a for the gas mixture are calculated as:

$${K}^{mix} = \sum {K}_{i} \cdot {y}_{i}$$

$${α}^{mix} = \sum {α}_{i} \cdot {y}_{i}$$

Entropy is calculated similar to enthalpy-initially reference entropy at a given temperature and pressure is calculated then change in entropy to the actual pressure and temperature in two steps-first an ideal step (no change in pressure), then a departure function to account for non-ideality at high pressure. Additionally, entropy of mixing is calculated.

$$S = {S}_{ref} + d {S}^{ideal} + {S}^{departure} + d {S}^{mixing} - R \cdot ln \frac{P}{{P}_{ref}}$$

Reference entropy is a sum of components mole fractions multiplied by entropy of formation at reference conditions

$${S}_{ref} = \sum {y}_{i} \cdot {dS}_{i}^{0}$$

where dSᵢ⁰ is the entropy of formation of component i at reference conditions.

### Calculate Ideal Entropy for Each Component:

$${dS}_{i}^{ideal} = A \cdot ln \frac{T}{{T}_{ref}} + B \cdot ( T - {T}_{ref} ) + \frac{C}{2} \cdot ( {T}^{2} - {T}_{ref}^{2} ) + \frac{D}{3} \cdot ( {T}^{3} - {T}_{ref}^{3} ) + \frac{E}{4} ( {T}^{4} - {T}_{ref}^{4} )$$

### Calculate Ideal Entropy for the Mixture:

$${dS}_{ideal} = \sum {y}_{i} \cdot {dS}_{i}^{ideal} .$$

### Calculate Departure Entropy:

$${S}^{departure} = R \cdot ln ( Z - B ) - ln \frac{Z + ( 1 + \sqrt{2} ) \cdot B}{Z + ( 1 - \sqrt{2} ) \cdot B} \cdot \frac{A \cdot R}{B \cdot \sqrt{8}} \cdot {K}^{mix} \cdot \frac{\sqrt{\frac{T}{{T}_{c}^{mix}}}}{\sqrt{{α}^{mix}}}$$

### Calculate Mixing Entropy for Key Components:

$${dS}^{mixing} = - R \cdot ( {N}_{{2}_{MOL}} \cdot ln ( {N}_{{2}_{MOL}} ) + {C}_{{1}_{MOL}} \cdot ln ( {C}_{{1}_{MOL}} ) )$$

### Compressor Performance Parameters Calculation

### Calculate Polytropic Head:

$${H}_{P} = ( {H}_{2} - {H}_{1} ) - \frac{( {S}_{2} - {S}_{1} ) \cdot ( {T}_{2} - {T}_{1} )}{ln \frac{{T}_{2}}{{T}_{1}}}$$

### Calculate Polytropic Efficiency:

$$η = \frac{{H}_{P}}{{H}_{2} - {H}_{1}}$$

### Calculate Compressor Actual Suction Flow:

$${F}_{act} , ACFM = {F}_{std} , MMSCFD * ( \frac{{P}_{std}}{{P}_{act}} ) * ( \frac{{T}_{act}}{{T}_{std}} ) * ( \frac{z}{1} ) * {10}^{6} * ( \frac{1}{24} ) * ( \frac{1}{60} )$$

### Calculate Inlet/Outlet Stream Densities:

$${Density}_{IN} , \frac{lb}{{ft}^{3}} = \frac{{P}_{in} * MW}{{Z}_{in} * R * {T}_{in}} * 0.0624 \\ {Density}_{OUT} , \frac{lb}{{ft}^{3}} = \frac{{P}_{out} * MW}{{Z}_{out} * R * {T}_{out}} * 0.0624$$

### Calculate Compressor Mass Flow:

$${F}_{mass} , \frac{lb}{h} = {F}_{act} , ACFM * {Density}_{IN} , \frac{lb}{{ft}^{3}} * 60$$

### Calculate Compressor Power:

$$POWER , BTU / m = ( {H}_{p} , \frac{BTU}{lb} * {F}_{mass} , \frac{lb}{min} ) \\ POWER , \frac{MMBTU}{h} = \frac{( POWER , \frac{BTU}{m} )}{16498.513} \\ stage POWER , MW = ( POWER , \frac{MMBTU}{h} ) / 3.4$$

### Compressor Total Absorbed Power:

$$SGC POWER , MW = 1 st stage POWER , MW + 2 nd stage POWER , MW$$

### Gas Turbine Performance Parameters Calculation

Input data includes Fuel Gas Consumption and Fuel Gas Higher Heating Value (HHV).

### Calculate Fuel Gas Lower Heating Value (LHV):

$$FG LHV , BTU / SCF = 0.9018 * FuelGasHHV$$

### Calculate Fuel Gas Heat Rate:

$$FG Heat Rate , MMBTU / h = 61 FY 447. CPV / 24 * FG LHV , BTU / SCF \\ FG Heat Rate , MW = FG Heat Rate , \frac{MMBTU}{h} * 0.2937$$

### Calculate Turbine Thermal Efficiency:

$$Turbine Efficiency , \% = \frac{SGC POWER , MW}{FG Heat Rate , MW} * 100$$

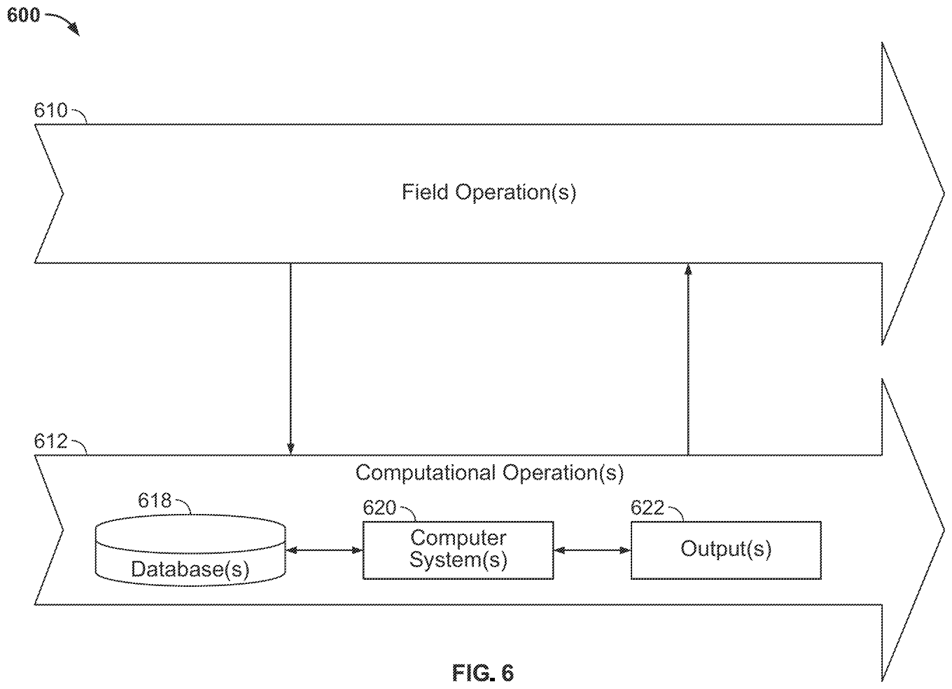

FIG. 6 illustrates hydrocarbon production operations 600 that include both one or more field operations 610 and one or more computational operations 612, which exchange information and control exploration for the production of hydrocarbons. In some implementations, outputs of techniques of the present disclosure (e.g., the method 300) can be performed before, during, or in combination with the hydrocarbon production operations 600, specifically, for example, either as field operations 610 or computational operations 612, or both.

Examples of field operations 610 include forming/drilling a wellbore, hydraulic fracturing, producing through the wellbore, injecting fluids (such as water) through the wellbore, to name a few. In some implementations, methods of the present disclosure can trigger or control the field operations 610. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 610 and responsively triggering the field operations 610 including, for example, generating plans and signals that provide feedback to and control physical components of the field operations 610. Alternatively, or in addition, the field operations 610 can trigger the methods of the present disclosure. For example, implementing physical components (including, for example, hardware, such as sensors) deployed in the field operations 610 can generate plans and signals that can be provided as input or feedback (or both) to the methods of the present disclosure.

Examples of computational operations 612 include one or more computer systems 620 that include one or more processors and computer-readable media (e.g., non-transitory computer-readable media) operatively coupled to the one or more processors to execute computer operations to perform the methods of the present disclosure. The computational operations 612 can be implemented using one or more databases 618, which store data received from the field operations 610 and/or generated internally within the computational operations 612 (e.g., by implementing the methods of the present disclosure) or both. For example, the one or more computer systems 620 process inputs from the field operations 610 to assess conditions in the physical world, the outputs of which are stored in the databases 618. For example, seismic sensors of the field operations 610 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 612 where they are stored in the databases 618 and analyzed by the one or more computer systems 620.

In some implementations, one or more outputs 622 generated by the one or more computer systems 620 can be provided as feedback/input to the field operations 610 (either as direct input or stored in the databases 618). The field operations 610 can use the feedback/input to control physical components used to perform the field operations 610 in the real world.

For example, the computational operations 612 can process the seismic data to generate three-dimensional (3D) maps of the subsurface formation. The computational operations 612 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 612 to process new information about the formation and control the drilling to adjust to the observed conditions in real-time.

The one or more computer systems 620 can update the 3D maps of the subsurface formation as information from one exploration well is received and the computational operations 612 can adjust the location of the next exploration well based on the updated 3D maps. Similarly, the data received from production operations can be used by the computational operations 612 to control components of the production operations. For example, production well and pipeline data can be analyzed to predict slugging in pipelines leading to a refinery and the computational operations 612 can control machine operated valves upstream of the refinery to reduce the likelihood of plant disruptions that run the risk of taking the plant offline.

In some implementations of the computational operations 612, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

FIG. 7 is a block diagram of an example computer system 700 used to provide computational functionalities associated with described algorithms, methods, functions, processes, flows, and procedures described in the present disclosure, according to some implementations of the present disclosure. The illustrated computer 702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI).

The computer 702 can serve in a role as a client, a network component, a server, a database, a persistency, or components of a computer system for performing the subject matter described in the present disclosure. The illustrated computer 702 is communicably coupled with a network 730. In some implementations, one or more components of the computer 702 can be configured to operate within different environments, including cloud-computing-based environments, local environments, global environments, and combinations of environments.

At a high level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 730 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 703. In some implementations, any or all of the components of the computer 702, including hardware or software components, can interface with each other or the interface 704 (or a combination of both), over the system bus 703. Interfaces can use an application programming interface (API) 712, a service layer 713, or a combination of the API 712 and service layer 713. The API 712 can include specifications for routines, data structures, and object classes. The API 712 can be either computer-language independent or dependent. The API 712 can refer to a complete interface, a single function, or a set of APIs.

The service layer 713 can provide software services to the computer 702 and other components (whether illustrated or not) that are communicably coupled to the computer 702. The functionality of the computer 702 can be accessible for all service consumers using this service layer. Software services, such as those provided by the service layer 713, can provide reusable, defined functionalities through a defined interface. For example, the interface can be software written in JAVA, C++, or a language providing data in extensible markup language (XML) format. While illustrated as an integrated component of the computer 702, in alternative implementations, the API 712 or the service layer 713 can be stand-alone components in relation to other components of the computer 702 and other components communicably coupled to the computer 702. Moreover, any or all parts of the API 712 or the service layer 713 can be implemented as child or sub-modules of another software module, enterprise application, or hardware module without departing from the scope of the present disclosure.

The computer 702 includes an interface 704. Although illustrated as a single interface 704 in FIG. 7, two or more interfaces 704 can be used according to particular needs, desires, or particular implementations of the computer 702 and the described functionality. The interface 704 can be used by the computer 702 for communicating with other systems that are connected to the network 730 (whether illustrated or not) in a distributed environment. Generally, the interface 704 can include, or be implemented using, logic encoded in software or hardware (or a combination of software and hardware) operable to communicate with the network 730. More specifically, the interface 704 can include software supporting one or more communication protocols associated with communications. As such, the network 730 or the interface's hardware can be operable to communicate physical signals within and outside of the illustrated computer 702.

The computer 702 includes a processor 705. Although illustrated as a single processor 705 in FIG. 7, two or more processors 705 can be used according to particular needs, desires, or particular implementations of the computer 702 and the described functionality. Generally, the processor 705 can execute instructions and can manipulate data to perform the operations of the computer 702, including operations using algorithms, methods, functions, processes, flows, and procedures as described in the present disclosure.

The computer 702 also includes a database 706 that can hold data for the computer 702 and other components connected to the network 730 (whether illustrated or not). For example, database 706 can be an in-memory, conventional, or a database storing data consistent with the present disclosure. In some implementations, database 706 can be a combination of two or more different database types (for example, hybrid in-memory and conventional databases) according to particular needs, desires, or particular implementations of the computer 702 and the described functionality. Although illustrated as a single database 706 in FIG. 7, two or more databases (of the same, different, or combination of types) can be used according to particular needs, desires, or particular implementations of the computer 702 and the described functionality. While database 706 is illustrated as an internal component of the computer 702, in alternative implementations, database 706 can be external to the computer 702.

The computer 702 also includes a memory 707 that can hold data for the computer 702 or a combination of components connected to the network 730 (whether illustrated or not). Memory 707 can store any data consistent with the present disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707 in FIG. 7, two or more memories 707 (of the same, different, or combination of types) can be used according to particular needs, desires, or particular implementations of the computer 702 and the described functionality. While memory 707 is illustrated as an internal component of the computer 702, in alternative implementations, memory 707 can be external to the computer 702.

The application 708 can be an algorithmic software engine providing functionality according to particular needs, desires, or particular implementations of the computer 702 and the described functionality. For example, application 708 can serve as one or more components, modules, or applications. Further, although illustrated as a single application 708, the application 708 can be implemented as multiple applications 708 on the computer 702. In addition, although illustrated as internal to the computer 702, in alternative implementations, the application 708 can be external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion and management circuits, including recharging, standby, and power management functionalities. In some implementations, the power-supply 714 can include a power plug to allow the computer 702 to be plugged into a wall socket or a power source to, for example, power the computer 702 or recharge a rechargeable battery.

There can be any number of computers 702 associated with, or external to, a computer system containing computer 702, with each computer 702 communicating over network 730. Further, the terms “client,” “user,” and other appropriate terminology can be used interchangeably, as appropriate, without departing from the scope of the present disclosure. Moreover, the present disclosure contemplates that many users can use one computer 702 and one user can use multiple computers 702.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

### Examples

In an example implementation, a method for controlling a gas turbine driven compressor includes measuring physical parameters of the gas turbine driven compressor; determining an efficiency of the gas turbine driven compressor based on the measured physical parameters, wherein the efficiency includes a compressor polytropic efficiency, an absorbed compressor power, and a thermal efficiency of the gas turbine driven compressor; determining that the efficiency is less than a peak efficiency of the gas turbine driven compressor; and in response, adjusting setpoints of the gas turbine driven compressor to increase the efficiency of the gas turbine driven compressor.

In an aspect combinable with the example implementation, adjusting setpoints of the gas turbine driven compressor includes adjusting one or more of a valve, a heat exchanger, a flow rate of a flow of gas, and a ratio of gas components in the flow of gas.

Another aspect combinable with any of the pervious aspects includes determining that the gas turbine driven compressor is approaching a surge or stonewall zone based on the measured physical parameters and determined efficiency; and in response, generating one or more alarms to alert operators of the gas turbine driven compressor.

Another aspect combinable with any of the pervious aspects includes predicting future performance of the gas turbine driven compressor using a trained machine learning model, where an input to the trained machine learning model includes the measured physical parameters, and an output of the trained machine learning model is a predicted efficiency over time.

Another aspect combinable with any of the pervious aspects includes determining that the predicted future performance is lower than the determined efficiency; and adjusting the setpoints of the gas turbine driven compressor to improve the predicted future performance.

Another aspect combinable with any of the pervious aspects includes training a machine learning model to predict future performance of the gas turbine driven compressor based on training data, the training data comprising measured physical parameters as inputs with determined efficiencies as corresponding labels.

In another aspect combinable with any of the pervious aspects, the polytropic efficiency is based on a Peng-Robinson equation of state.

Another aspect combinable with any of the pervious aspects includes rendering for display on a display device a graphical user interface comprising visual representations of the measured physical parameters and the determined efficiency.

In another aspect combinable with any of the pervious aspects, measuring the physical parameters and determining the efficiency occur in real time.

In another example implementation, a system for controlling a gas turbine driven compressor includes at least one processor and a memory storing instructions that, when executed by the at least one processor, cause the at least one processor to perform operations including measuring physical parameters of the gas turbine driven compressor; determining an efficiency of the gas turbine driven compressor based on the measured physical parameters, wherein the efficiency includes a compressor polytropic efficiency, an absorbed compressor power, and a thermal efficiency of the gas turbine driven compressor; determining that the efficiency is less than a peak efficiency of the gas turbine driven compressor; and in response, adjusting setpoints of the gas turbine driven compressor to increase the efficiency of the gas turbine driven compressor.

In an aspect combinable with the example implementation, adjusting setpoints of the gas turbine driven compressor includes adjusting one or more of a valve, a heat exchanger, a flow rate of a flow of gas, and a ratio of gas components in the flow of gas.

In another aspect combinable with any of the pervious aspects, the operations include determining that the gas turbine driven compressor is approaching a surge or stonewall zone based on the measured physical parameters and determined efficiency; and in response, generating one or more alarms to alert operators of the gas turbine driven compressor.

In another aspect combinable with any of the pervious aspects, the operations include predicting future performance of the gas turbine driven compressor using a trained machine learning model, where an input to the trained machine learning model includes the measured physical parameters, and an output of the trained machine learning model is a predicted efficiency over time.

In another aspect combinable with any of the pervious aspects, the operations include determining that the predicted future performance is lower than the determined efficiency; and adjusting the setpoints of the gas turbine driven compressor to improve the predicted future performance.

In another aspect combinable with any of the pervious aspects, the operations include training a machine learning model to predict future performance of the gas turbine driven compressor based on training data, the training data comprising measured physical parameters as inputs with determined efficiencies as corresponding labels.

In another aspect combinable with any of the pervious aspects, the polytropic efficiency is based on a Peng-Robinson equation of state.

In another example implementation, one or more non-transitory machine-readable storage devices storing instructions for controlling a gas turbine driven compressor, the instructions being executable by one or more processors, to cause performance of operations including measuring physical parameters of the gas turbine driven compressor; determining an efficiency of the gas turbine driven compressor based on the measured physical parameters, wherein the efficiency includes a compressor polytropic efficiency, an absorbed compressor power, and a thermal efficiency of the gas turbine driven compressor; determining that the efficiency is less than a peak efficiency of the gas turbine driven compressor; and in response, adjusting setpoints of the gas turbine driven compressor to increase the efficiency of the gas turbine driven compressor.

In an aspect combinable with the example implementation, adjusting setpoints of the gas turbine driven compressor includes adjusting one or more of a valve, a heat exchanger, a flow rate of a flow of gas, and a ratio of gas components in the flow of gas.

In another aspect combinable with any of the pervious aspects, the operations include determining that the gas turbine driven compressor is approaching a surge or stonewall zone based on the measured physical parameters and determined efficiency; and in response, generating one or more alarms to alert operators of the gas turbine driven compressor.

In another aspect combinable with any of the pervious aspects, the operations include predicting future performance of the gas turbine driven compressor using a trained machine learning model, where an input to the trained machine learning model includes the measured physical parameters, and an output of the trained machine learning model is a predicted efficiency over time.

1. A method for controlling a gas turbine driven compressor, the method comprising:
measuring physical parameters of the gas turbine driven compressor;
determining an efficiency of the gas turbine driven compressor based on the measured physical parameters, wherein the efficiency includes a compressor polytropic efficiency, an absorbed compressor power, and a thermal efficiency of the gas turbine driven compressor;
determining that the efficiency is less than a peak efficiency of the gas turbine driven compressor; and
in response, adjusting setpoints of the gas turbine driven compressor by controlling valve positions in the gas turbine driven compressor to increase the efficiency of the gas turbine driven compressor.

2. The method of claim 1, wherein adjusting setpoints of the gas turbine driven compressor comprises adjusting the valve positions to control one or more of a temperature of a heat exchanger, a flow rate of a flow of gas, and a ratio of gas components in the flow of gas.

3. The method of claim 1, further comprising:
determining that the gas turbine driven compressor is approaching a surge or stonewall zone based on the measured physical parameters and determined efficiency; and
in response, generating one or more alarms to alert operators of the gas turbine driven compressor.

4. The method of claim 1, further comprising:
predicting future performance of the gas turbine driven compressor using a trained machine learning model, where an input to the trained machine learning model includes the measured physical parameters, and an output of the trained machine learning model is a predicted efficiency over time.

5. The method of claim 4, further comprising:
determining that the predicted future performance is lower than the determined efficiency; and
adjusting the setpoints of the gas turbine driven compressor to improve the predicted future performance.

6. The method of claim 1, further comprising:
training a machine learning model to predict future performance of the gas turbine driven compressor based on training data, the training data comprising measured physical parameters as inputs with determined efficiencies as corresponding labels.

7. The method of claim 1, wherein the polytropic efficiency is based on a Peng-Robinson equation of state.

8. The method of claim 1, further comprising:
rendering for display on a display device a graphical user interface comprising visual representations of the measured physical parameters and the determined efficiency.

9. The method of claim 1, wherein measuring the physical parameters and determining the efficiency occur in real time.

10. A system for controlling a gas turbine driven compressor,
the system comprising:
at least one processor and a memory storing instructions that, when executed by the at least one processor, cause the at least one processor to perform operations comprising:
measuring physical parameters of the gas turbine driven compressor;
determining an efficiency of the gas turbine driven compressor based on the measured physical parameters, wherein the efficiency includes a compressor polytropic efficiency, an absorbed compressor power, and a thermal efficiency of the gas turbine driven compressor;
determining that the efficiency is less than a peak efficiency of the gas turbine driven compressor; and
in response, adjusting setpoints of the gas turbine driven compressor by controlling valve positions in the gas turbine driven compressor to increase the efficiency of the gas turbine driven compressor.

11. The system of claim 10, wherein adjusting setpoints of the gas turbine driven compressor comprises adjusting the valve positions to control one or more of a temperature of a heat exchanger, a flow rate of a flow of gas, and a ratio of gas components in the flow of gas.

12. The system of claim 10, wherein the operations further comprise:
determining that the gas turbine driven compressor is approaching a surge or stonewall zone based on the measured physical parameters and determined efficiency; and
in response, generating one or more alarms to alert operators of the gas turbine driven compressor.

13. The system of claim 10, wherein the operations further comprise:
predicting future performance of the gas turbine driven compressor using a trained machine learning model, where an input to the trained machine learning model includes the measured physical parameters, and an output of the trained machine learning model is a predicted efficiency over time.

14. The system of claim 13, wherein the operations further comprise:
determining that the predicted future performance is lower than the determined efficiency; and
adjusting the setpoints of the gas turbine driven compressor to improve the predicted future performance.

15. The system of claim 10, wherein the operations further comprise:
training a machine learning model to predict future performance of the gas turbine driven compressor based on training data, the training data comprising measured physical parameters as inputs with determined efficiencies as corresponding labels.

16. The system of claim 10, wherein the polytropic efficiency is based on a Peng-Robinson equation of state.

17. One or more non-transitory machine-readable storage devices storing instructions for controlling a gas turbine driven compressor, the instructions being executable by one or more processors, to cause performance of operations comprising:
measuring physical parameters of the gas turbine driven compressor;
determining an efficiency of the gas turbine driven compressor based on the measured physical parameters, wherein the efficiency includes a compressor polytropic efficiency, an absorbed compressor power, and a thermal efficiency of the gas turbine driven compressor;
determining that the efficiency is less than a peak efficiency of the gas turbine driven compressor; and
in response, adjusting setpoints of the gas turbine driven compressor by controlling valve positions in the gas turbine driven compressor to increase the efficiency of the gas turbine driven compressor.

18. The non-transitory machine-readable storage devices of claim 17, wherein adjusting setpoints of the gas turbine driven compressor comprises adjusting the valve positions to control one or more of a temperature of a heat exchanger, a flow rate of a flow of gas, and a ratio of gas components in the flow of gas.

19. The non-transitory machine-readable storage devices of claim 17, wherein the operations further comprise:
determining that the gas turbine driven compressor is approaching a surge or stonewall zone based on the measured physical parameters and determined efficiency; and
in response, generating one or more alarms to alert operators of the gas turbine driven compressor.

20. The non-transitory machine-readable storage devices of claim 17, wherein the operations further comprise:
predicting future performance of the gas turbine driven compressor using a trained machine learning model, where an input to the trained machine learning model includes the measured physical parameters, and an output of the trained machine learning model is a predicted efficiency over time.
